(19) United States
(12) Patent Application Publication
(10) Pub. No.: US 2023/0176559 A1
(43) Pub. Date: Jun. 8, 2023

(54) DATA MANAGEMENT DEVICE AND DATA MANAGEMENT METHOD

(71) Applicant: FANUC CORPORATION, Minamitsuru-gun, Yamanashi (JP)

(72) Inventor: Tsuguhiro AOKI, Yamanashi (JP)

(21) Appl. No.: 17/924,267

(22) PCT Filed: May 20, 2021
(86) PCT No.: PCT/JP2021/019120

§ 371 Date: Nov. 9, 2022

(30) Foreign Application Priority Data
May 27, 2020 (JP) 2020-092572

(51) Int. Cl. G05B 23/02

(52) U.S. Cl. CPC G05B 23/0259

(57) ABSTRACT

The present invention provides test data for various machines for testing an application. This data management device comprises: an input unit that accepts input of data output from at least one device; a storage unit that stores, as test data, the test data input via the input unit; a communication control unit that acquires, from the storage unit, test data requested on the basis of a request from an external device, and controls transmission of the requested test data to the external device; and a communication unit that transmits the requested test data to the external device on the basis of the transmission control by the communication control unit.

### TECHNICAL FIELD

The present invention relates to a data management device and a data management method.

### BACKGROUND ART

An application for sensing an anomaly caused in an instrument such as a machine tool or an industrial robot, an application for monitoring the degree of deterioration of a component such as a tool included in the instrument, etc. have been developed by a machine tool builder, a third party, etc. In development of the application, test data on the instrument needs to be prepared according to the application, and debugging, etc. need to be performed to check whether or not the application operates as designed.

On this point, the following technique in development of the application has been known: an application is efficiently developed utilizing a device emulator that operates on a personal computer to emulate device operation. See Patent Document 1, for example.
Patent Document 1: Japanese Unexamined Patent Application, Publication No. 2004-185595

### DISCLOSURE OF THE INVENTION

### Problems to be Solved by the Invention

In development of the application by an application developer such as the machine tool builder or the third party, considerable cost and man-hours are required to prepare and test the actual instrument such as the machine tool or the industrial robot, and it is difficult to smoothly develop the application.

In other words, it is difficult to prepare and test all instruments supported by the developed application, and it is difficult for the application developer to prepare various types of test data.

For these reasons, there has been a demand for test data on various instruments for testing applications.

### Means for Solving the Problems

(1) One aspect of a data management device of the present disclosure includes an input unit configured to input data from at least one instrument, a storage unit configured to store, as test data, the data input from the input unit, a communication control unit configured to acquire, from the storage unit, requested test data based on a request from an external device and control transmission of the requested test data to the external device, and a communication unit configured to transmit the requested test data to the external device based on transmission control by the communication control unit.

(2) One aspect of a data management method of the present disclosure includes inputting data from at least one instrument, storing, as test data, the input data in a storage unit, acquiring, from the storage unit, requested test data based on a request from an external device and controlling transmission of the requested test data to the external device, and transmitting the requested test data to the external device based on transmission control.

### Effects of the Invention

According to one aspect, the test data on various instruments for testing an application can be provided.

### BRIEF DESCRIPTION OF THE DRAWINGS

FIG. 1 is a diagram showing a functional configuration of a data management device according to a first embodiment;

FIG. 2 is a table showing one example of normal system time-series data on a robot;

FIG. 3 is a table showing one example of abnormal system time-series data on the robot;

FIG. 4 is a table showing one example of normal system time-series data on a control device;

FIG. 5 is a table showing one example of time-series data on a sensor;

FIG. 6 is a view showing one example of an editing tool setting screen;

FIG. 7 is a view showing one example of an editing tool setting screen for creating new abnormal system test data;

FIG. 8 is a view showing one example of an editing tool setting screen for creating a combination of normal system test data and abnormal system test data as new test data;

FIG. 9 is a flowchart showing, as an example, the processing of editing the test data according to the first embodiment;

FIG. 10 is a view showing one example of the editing tool setting screen;

FIG. 11 is a chart showing one example of a time series of steps in each of which a corresponding one of three instruments as robots operates;

FIG. 12 is a flowchart showing, as an example, the processing of editing the test data in a case where stay occurs;

FIG. 13 is a view showing one example of the editing tool setting screen;

FIG. 14 is a view showing one example of the editing tool setting screen;

FIG. 15 is a flowchart showing, as an example, the processing of editing the test data in a case where a plurality of instruments is selected;

FIG. 16 is a graph showing one example of time-series data on a deterioration level of a reducer for a robot shaft;

FIG. 17A is a table showing one example of time-series data for a reducer diagnosis, the time-series data having a date-and-time field and a deterioration level field;

FIG. 17B is a view showing one example of the editing tool setting screen;

FIG. 18 is a flowchart showing, as an example, the processing of editing the test data in a case where desired test data is extracted from the time-series data;

FIG. 19 is a view showing one example of the editing tool setting screen;

FIG. 20 is a flowchart showing, as an example, the processing of editing the test data in a case where a period to be extracted is specified;

FIG. 21A is a view showing one example of the editing tool setting screen;

FIG. 21B is a view showing one example of the editing tool setting screen after the deterioration level has been changed;

FIG. 22 is a flowchart showing, as an example, the processing of editing the test data in a case where the parameter of the time-series data is changed;

FIG. 23 is a flowchart for describing the processing of the data management device;

FIG. 24 is a diagram showing a functional configuration of a data management device according to a second embodiment;

FIG. 25 is a view showing one example of a transmission tool setting screen;

FIG. 26 is a flowchart showing, as an example, the processing of transmitting test data according to the second embodiment;

FIG. 27 is a view showing one example of the transmission tool setting screen;

FIG. 28 is a flowchart showing, as an example, the processing of transmitting the test data in a case where a transmission interval is changed;

FIG. 29A is a view showing one example of an editing tool setting screen;

FIG. 29B is a view showing one example of the editing tool setting screen including the list of time stamps of selected test data;

FIG. 29C is a view showing one example of the editing tool setting screen after editing of the time stamps of the selected test data; and

FIG. 30 is a flowchart showing, as an example, the processing of editing the test data in a case where the time stamp is changed.

### PREFERRED MODE FOR CARRYING OUT THE INVENTION

Hereinafter, a first embodiment will be described as one example.

### First Embodiment

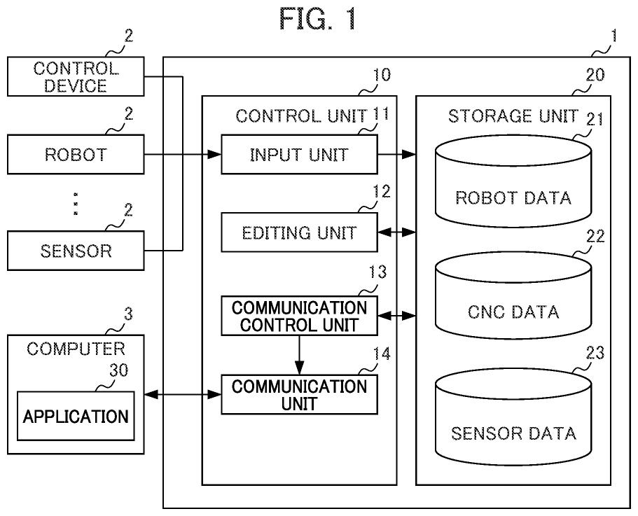

FIG. 1 is a diagram showing a functional configuration of a data management device 1 according to a first embodiment.

The data management device 1 is an information processing device, such as a server, communicably connected to various instruments 2 utilized in a factory and a computer 3 of, e.g., a manufacturer of the instrument 2 or a third party developing an application.

The instruments 2 include, for example, a control device, a robot, and a sensor, and the data management device 1 includes an interface for communicating with each of these instruments 2. Note that the instruments 2 are not limited to the control device, the robot, and the sensor, and may include a machine tool, an injection molding machine, an industrial machine such as an industrial robot, peripheral equipment such as a carrier or a conveyer, and a mobile terminal such as a tablet terminal or a smartphone with which a worker makes an input.

Two or more control devices, robots, sensors, etc. may be, as the instruments 2, connected to the data management device 1.

The instrument 2 as the control device will be described as a numerical control device (CNC) that controls a machine tool, but may be a robot control device that controls a robot.

The computer 3 is a computer device such as a personal computer, a tablet terminal, or a smartphone. For checking or debugging the function of a developed application 30, the computer 3 requests the data management device 1 to transmit test data, and acquires the requested test data. Note that the application 30 is stored in a storage unit (not shown), such as an HDD, included in the computer 3, and is executed by a control unit (not shown), such as a processor, included in the computer 3.

Two or more computers 3 may be connected to the data management device 1.

The data management device 1 has a control unit 10 and a storage unit 20. The control unit 10 has an input unit 11, an editing unit 12, a communication control unit 13, and a communication unit 14. The control unit 10 executes predetermined software (a data management program) stored in the storage unit 20, thereby implementing each function of the present embodiment.

The storage unit 20 includes, for example, a solid state drive (SSD) and a hard disk drive (HDD), and stores the predetermined software (the data management program). The storage unit 20 has storage areas for robot data 21, CNC data 22, and sensor data 23.

### <Robot Data 21>

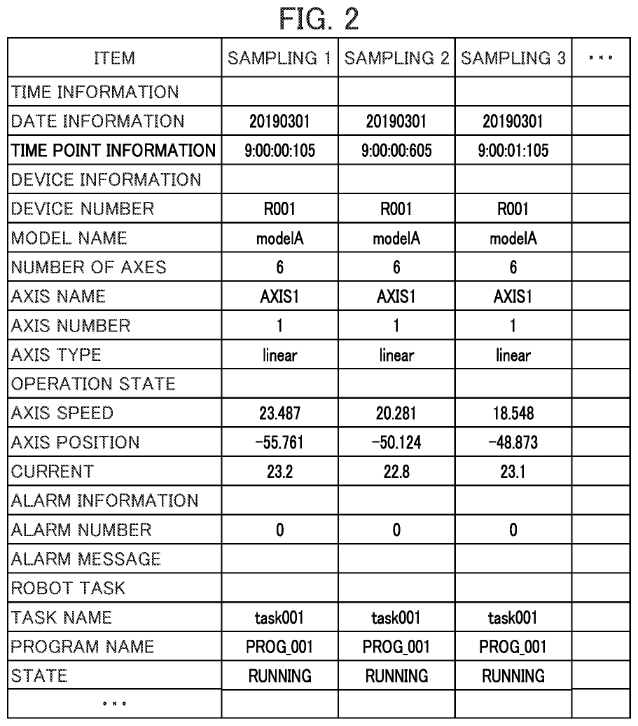

FIG. 2 is a table showing one example of normal system time-series data on the robot.

As shown in FIG. 2, time-series data with a plurality of items is, for example, output from the instrument 2 as the robot in every predetermined sampling cycle and is input to the later-described input unit 11, and is sequentially recorded in the storage area for the robot data 21. In this example, an operation state, alarm information, etc. are recorded together with a robot model name and a control program name as key information.

Moreover, in this example, time-series data with various items output from the robot from the start to the end of a control program in a case where an instrument 2 as a robot whose device number is “R001” and whose model is “modelA” executes a control program “PROG_001” to perform workpiece gripping is recorded in a cycle of 500 msec. The time-series data of FIG. 2 is saved in the robot data 21 as test data including, as data attributes, a device number “R001”, a model “modelA”, a program “PROG_001”, and a state “Normal System” and having a file name “data001”, for example.

Note that as the method for notifying the start and end of the control program “PROG_001”, “RUNNING” as robot task state information may be output together with the control program name when the instrument 2 as the robot starts the control program “PROG_001”, and “END” may be output when the control program ends, as shown in FIG. 2. With this configuration, the data management device 1 can detect the start of the control program “PROG_001” by taking, as a trigger, switching of the robot task state information in the time-series data to “RUNNING”, and can detect the end of the control program by taking, as a trigger, switching to “END”.

Similarly, although not shown in the figure, in a case where an instrument 2 as a robot whose device number is “R001” and whose model is “modelA” executes a control program “PROG_002” instead of a control program “PROG_001” to perform workpiece loading, the data management device 1 may record, in the robot data 21, time-series data with various items output from the robot from the start to the end of the control program in a predetermined sampling cycle of, e.g., 500 msec. In this case, the data management device 1 can save, in the robot data 21, the time-series data as test data including, as data attributes, a device number “R001”, a model “modelA”, a program “PROG_002”, and a state “Normal System” and having a file name “data002”.

Further, although not shown in the figure, in a case where an instrument 2 as a robot whose device number is “R001” and whose model is “modelA” executes another control program “PROG_003” to perform screw tightening, the data management device 1 may record time-series data with various items output from the robot from the start to the end of the control program in a predetermined sampling cycle of, e.g., 500 msec. In this case, the data management device 1 can save, in the robot data 21, the time-series data as test data including, as data attributes, a device number “R001”, a model “modelA”, a program “PROG_003”, and a state “Normal System” and having a file name “data003”.

An instrument 2 as a robot whose device number is “R001” and whose model is “modelA” may execute each of n (e.g., 100) normal system control programs, and accordingly, the data management device 1 may save, in the robot data 21, n pieces of normal system time-series data output from the robot with file names “data001” to “data00n”. In this case, the data management device 1 can store, in the storage unit 20, a normal system robot data table (not shown) with each of the n control programs associated with a corresponding one of the n normal system time-series data file names (n is an integer of two or greater).

In the robot data 21, the data management device 1 may store, as test data, abnormal system time-series data indicating that, e.g., the instrument 2 as the robot is stopped during operation thereof.

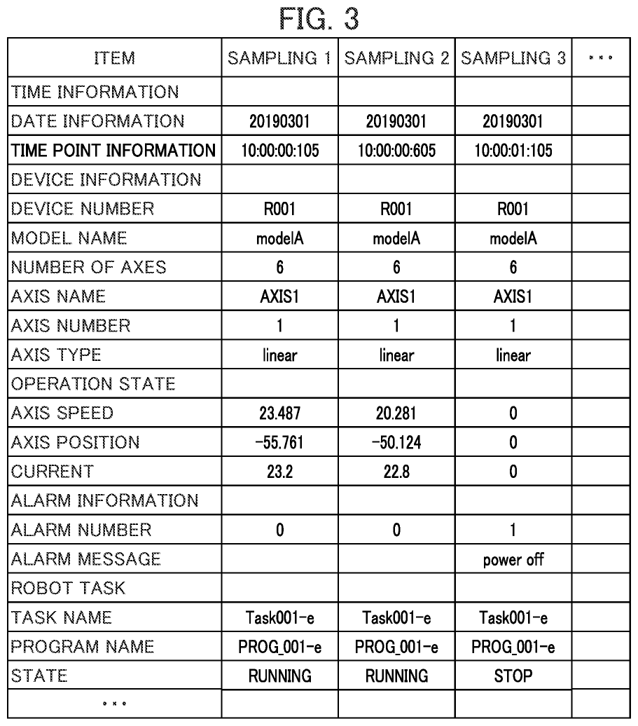

FIG. 3 is a table showing one example of abnormal system time-series data on the robot.

As shown in FIG. 3, an instrument 2 as a robot whose device number is “R001” and whose model is “modelA” executes, for example, a control program “PROG_001-e” for stopping the robot during workpiece gripping and outputting power-off alarm information, and accordingly, time-series data with various items output from the robot from the start to the end of the control program is recorded in a cycle of 500 msec. In this example, in the alarm information in Sampling 3, an alarm number “1” indicating an abnormality and an alarm message “power off” are recorded. The time-series data of FIG. 3 is saved in the robot data 21 as test data including, as data attributes, a device number “R001”, a model “modelA”, a program “PROG_001-e”, and a state “Abnormal System” and having a file name “data001-e”, for example.

Similarly, although not shown in the figure, in a case where an instrument 2 as a robot whose device number is “R001” and whose model is “modelA” executes a control program “PROG_002-e” for performing abnormal system workpiece loading instead of an abnormal system control program “PROG_001-e”, the data management device 1 may record time-series data with various items output from the robot from the start to the end of the control program in a predetermined sampling cycle of, e.g., 500 msec. In this case, the data management device 1 can save, in the robot data 21, the time-series data as test data including, as data attributes, a device number “R001”, a model “modelA”, a program “PROG_002-2”, and a state “Abnormal System” and having a file name “data002-e”.

Further, although not shown in the figure, in a case where an instrument 2 as a robot whose device number is “R001” and whose model is “modelA” executes another control program “PROG_003-e” for performing abnormal system screw tightening, the data management device 1 may record time-series data with various items output from the robot from the start to the end of the control program in a predetermined sampling cycle of, e.g., 500 msec. In this case, the data management device 1 can save, in the robot data 21, the time-series data as test data including, as data attributes, a device number “R001”, a model “modelA”, a program “PROG_003-e”, and a state “Abnormal System” and having a file name “data003-e”.

An instrument 2 as a robot whose device number is “R001” and whose model is “modelA” may execute each of n abnormal system control programs, and accordingly, the data management device 1 may save, in the robot data 21, n pieces of abnormal system time-series data output from the robot with file names “data001-e” to “data00n-e”. In this case, as in the case of the normal system, the data management device 1 can store, in the storage unit 20, an abnormal system robot data table (not shown) with each of the n abnormal system control programs associated with a corresponding one of the n abnormal system time-series data file names.

Note that a single instrument 2 as a robot whose device number is “R001” and whose model is “modelA” executes each of n normal system control programs and n abnormal system control programs, and accordingly, the data management device 1 acquires, as test data, n pieces of normal system time-series data and n pieces of abnormal system time-series data, but is not limited thereto. For example, the data management device 1 may cause each of multiple other instruments 2 as robots connected to the data management device 1 and having a device number “R002” and a model “modelA” to execute a corresponding one of n normal system control programs and a corresponding one of n abnormal system control programs. The data management device 1 can acquire n pieces of normal system time-series data and n pieces of abnormal system time-series data from the plurality of instruments 2, and can store such data as test data in the robot data 21.

### <CNC Data 22>

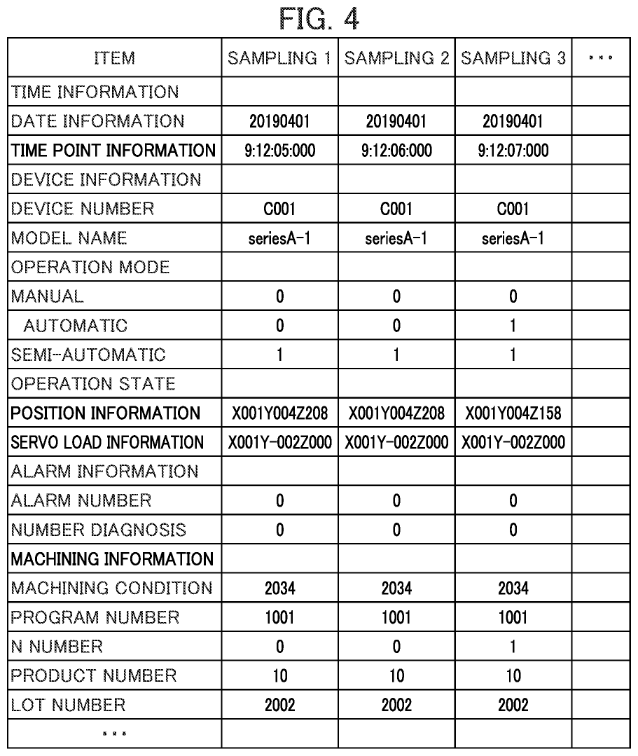

FIG. 4 is a table showing one example of normal system time-series data on the control device.

As shown in FIG. 4, time-series data with a plurality of items is output from the instrument 2 as the control device in every predetermined sampling cycle and is input to the later-described input unit 11, and is sequentially recorded in the CNC data 22, for example. In this example, an operation state, alarm information, etc. are recorded together with a control device model name and a machining program name as key information.

The time-series data of FIG. 4 can be, in the CNC data 22, saved as test data including, data attributes, a device number “C001”, a model “seriesA-1”, a program “1001”, and a state “Normal System” and having a data name “data1001”.

Similarly, although not shown in the figure, an instrument 2 as a control device whose device number is “C001” and whose model is “seriesA-1” may execute each of m (e.g., 100) normal system machining programs, and accordingly, the data management device 1 may save, in the CNC data 22, m pieces of normal system time-series data output from the control device with file names “data1001” to “data100m”. Although not shown in the figure, an instrument 2 as a control device whose device number is “C001” and whose model is “seriesA-1” may execute each of m abnormal system machining programs, and accordingly, the data management device 1 may save, in the CNC data 22, m pieces of abnormal system time-series data from the control device with file names “data1001-e” to “data100m-e”. Note that m is an integer of two or greater.

In this case, the data management device 1 can store, in the storage unit 20, a normal system CNC data table (not shown) with each of the m normal system machining programs associated with a corresponding one of the m normal system time-series data file names. Moreover, the data management device 1 can store, in the storage unit 20, an abnormal system CNC data table (not shown) with each of the m abnormal system machining programs associated with a corresponding one of the m abnormal system time-series data file names.

Note that a single instrument 2 as a control device whose device number is “C001” and whose model is “seriesA-1” executes each of m normal system machining programs and m abnormal system machining programs, and accordingly, the data management device 1 acquires, as test data, m pieces of normal system time-series data and m pieces of abnormal system time-series data, but is not limited thereto. For example, the data management device 1 may cause each of multiple other instruments 2 as control devices connected to the data management device 1 and having a device number “C002” and a model “seriesA-1” to execute a corresponding one of m normal system machining programs and m abnormal system machining programs. With this configuration, the data management device 1 can acquire m pieces of normal system time-series data and m pieces of abnormal system time-series data from the plurality of instruments 2, and can save such data as test data in the CNC data 22.

### <Sensor Data 23>

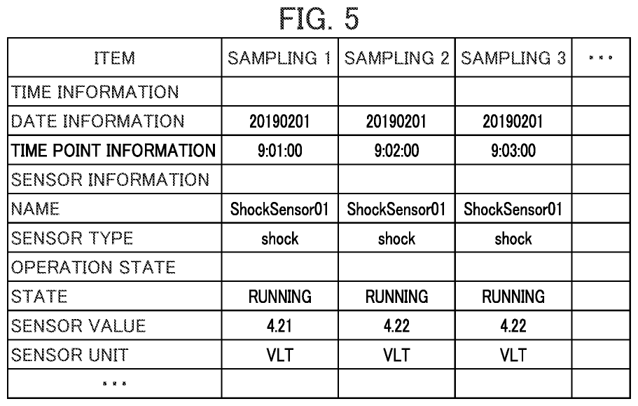

FIG. 5 is a table showing one example of time-series data on the sensor.

As shown in FIG. 5, time-series data with a plurality of items such as vibration and a temperature detected by instruments 2 as sensors arranged in, e.g., a machine tool is output in every predetermined sampling cycle and is input to the later-described input unit 11, and is sequentially recorded in the sensor data 23.

### <Control Unit 10>

The control unit 10 of the data management device 1 as shown in FIG. 1 has a central processing unit (CPU), a ROM, a RAM, a complementary metal-oxide-semiconductor (CMOS) memory, etc., and these components are communicably connected to each other via a bus. Such a configuration is well-known by those skilled in the art.

The CPU is a processor that controls the data management device 1 as a whole. The CPU reads a system program and an application program saved in the ROM via the bus, and controls the entirety of the data management device 1 according to the system program and the application program. With this configuration, the control unit 10 implements the functions of the input unit 11, the editing unit 12, the communication control unit 13, and the communication unit 14, as shown in FIG. 1. The RAM temporarily saves various types of data such as calculation data and display data. The CMOS memory is backed up by a not-shown battery, and is configured as a non-volatile memory that holds a storage state thereof even if the data management device 1 is powered off.

For example, the input unit 11 inputs time-series data from each instrument 2 in such a manner that each instrument 2 executes a normal or abnormal system program. The input unit 11 stores, as test data, each piece of input time-series data in any of the robot data 21, the CNC data 22, and the sensor data 23 according to the instrument 2.

The test data stored in the robot data 21, the CNC data 22, and the sensor data 23 may be acquired from each instrument 2 in a constant cycle by polling, or may be acquired in a specific cycle. Alternatively, the data may be transmitted from the instrument 2 randomly according to occurrence of a particular event.

Note that the input unit 11 inputs the time-series data via an interface provided between the data management device 1 and the instrument 2 and having the function of converting, e.g., an electric signal, a communication protocol, or a data format.

In a case where the instrument 2 complies with a protocol such as OPC UA (registered trademark) or MTConnect (registered trademark), the input unit 11 can input the time-series data in a predetermined data format by means of software. The communication interface is not limited to a wired manner, and for example, the data management device 1 and the instrument 2 may be connected to each other via a wireless LAN.

The communication control unit 13 acquires, based on a request from the computer 3 as an external device, requested test data from the storage unit 20, and controls transmission of the requested test data to the computer 3.

The communication unit 14 is, for example, a communication interface, and based on transmission control by the communication control unit 13, converts the requested test data into the protocol with which the instrument 2 complies, such as OPC UA (registered trademark) or MTConnect (registered trademark), and transmits such data to the computer 3.

The editing unit 12 edits, according to a request from the computer 3, the test data stored in the robot data 21, the CNC data 22, and the sensor data 23 in the storage unit 20. The editing unit 12 stores the edited test data in the storage unit 20.

Hereinafter, operation of the editing unit 12 in the following cases will be described: (1) a case where test data is newly created using an editing tool for a process; (2) a case where test data for, e.g., a load test is created using an editing tool; (3) a case where desired test data is created using an editing tool; and (4) a case where a test data parameter is changed using an editing tool. Note that a case where the instrument 2 is the robot will be described below, but the same also applies to the control device, the sensor, or a combination thereof.

(1) Case where Test Data is Newly Created Using Editing Tool for Process

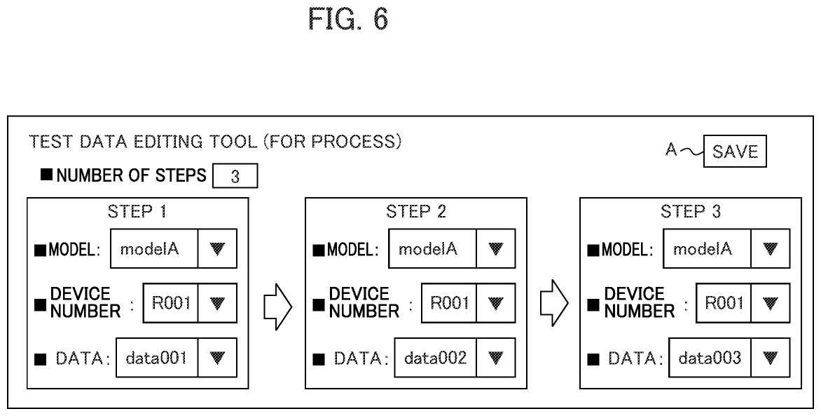

FIG. 6 is a view showing one example of an editing tool setting screen.

For example, as shown in FIG. 6, in a case where the editing unit 12 has received, from the computer 3, a request for test data for a line on which three steps of workpiece gripping, workpiece loading, and screw tightening are executed by a single instrument 2 as a robot, the editing unit 12 displays an editing tool setting screen (for a process) on a display device (not shown), such as a liquid crystal display, included in the computer 3.

Based on input operation by a user via an input device (not shown), such as a keyboard or a touch panel, included in the computer 3, the computer 3 inputs “3” as the number of steps on the editing tool setting screen (for the process). Accordingly, as shown in FIG. 6, a screen for setting each of three steps is shown on the editing tool setting screen (for the process) displayed on the display device (not shown) of the computer 3.

For example, in a case where the computer 3 has selected, based on the user's input operation, a robot whose model is “modelA” for each of Steps 1 to 3, the editing unit 12 may use the selected model “modelA” as key information to conduct a search on the data stored in the storage unit 20, thereby specifying device number candidates and data candidates. On the editing tool setting screen (for the process) of FIG. 6, the computer 3 may select a device number “R001” as a single robot that performs each step based on the user's input operation. Based on the user's input operation, the computer 3 may select normal system test data “data001”, “data002”, and “data003” as test data for each step of workpiece gripping, workpiece loading, and screw tightening.

Then, in a case where the user has clicked a “SAVE” button A on the editing tool setting screen (for the process), the computer 3 transmits, to the data management device 1, a signal including the setting contents set on the editing tool setting screen.

Based on the setting contents included in the signal received from the computer 3, the editing unit 12 reads, from the storage unit 20, test data including a model “modelA” and a device number “R001” as data attributes and having a file name “data001”, “data002”, and “data003”. The editing unit 12 sorts the read test data with the file names “data001”, “data002”, and “data003” in the order of the steps, combines such data, and stores new test data (e.g., a file name “data0123”) in the storage unit 20.

The communication control unit 13 acquires the created new test data from the storage unit 20 based on the request from the computer 3, and controls transmission of the requested new test data to the computer 3. Then, the communication unit 14 converts, based on transmission control by the communication control unit 13, the requested test data into a protocol with which the instrument 2 complies, such as OPC UA (registered trademark) or MTConnect (registered trademark), and transmits such data to the computer 3.

Accordingly, the computer 3 can check or debug the function of an application 30 for the line on which three steps of workpiece gripping, workpiece loading, and screw tightening are executed by the single instrument 2 as the robot, for example.

Note that the editing unit 12 creates the new normal system test data, but may create new abnormal system test data or create a combination of normal system test data and abnormal system test data as new test data.

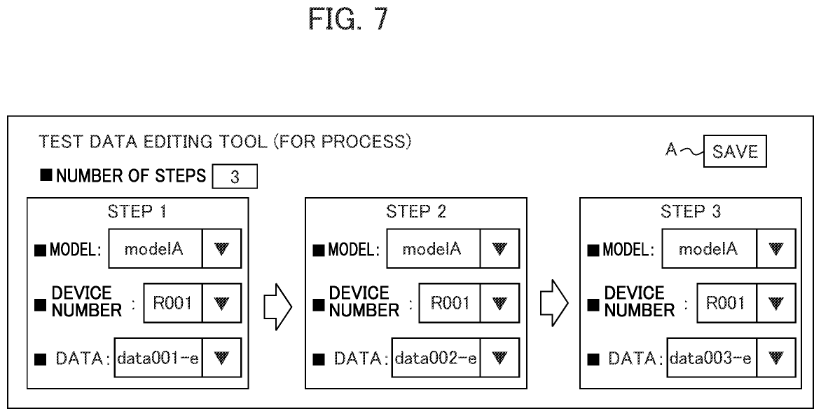

FIG. 7 is a view showing one example of an editing tool setting screen for creating the new abnormal system test data.

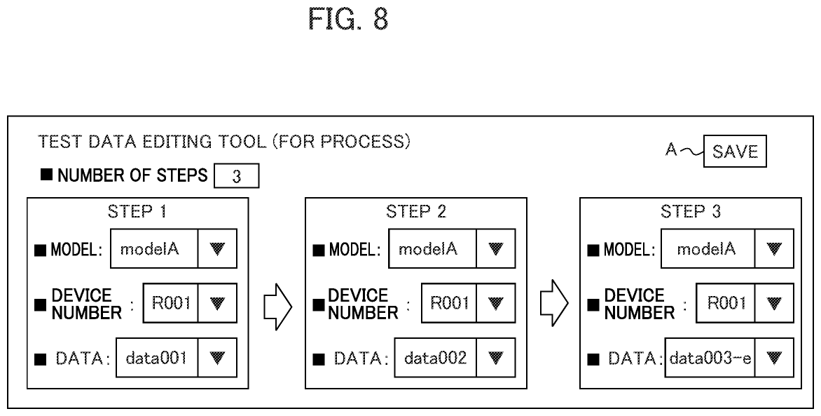

FIG. 8 is a view showing one example of an editing tool setting screen for creating the combination of the normal system test data and the abnormal system test data as the new test data.

With this configuration, a single robot can repeatedly perform abnormal system operation, a plurality of robots can perform abnormal system operation, or test data that cannot be created usually can be created.

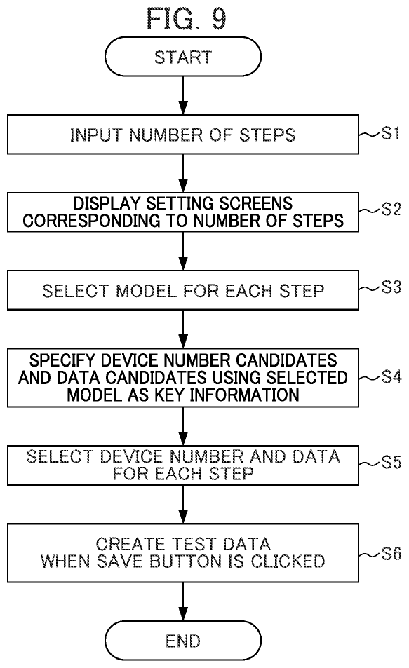

FIG. 9 is a flowchart showing, as an example, the processing of editing the test data according to the present embodiment.

In Step S1, the computer 3 inputs, based on the user's input operation, the number of steps on the editing tool setting screen (for the process) displayed on the display device (not shown) of the computer 3.

In Step S2, the computer 3 displays setting screens corresponding to the number of steps input in Step S1 on the editing tool setting screen (for the process) displayed on the display device (not shown) of the computer 3.

In Step S3, the computer 3 selects the model for each step based on the user's input operation.

In Step S4, the editing unit 12 of the data management device 1 uses the model selected for each step in Step S3 as key information to specify device number candidates and data candidates.

In Step S5, the computer 3 selects the device number and the data for each step based on the user's input operation.

In Step S6, in a case where the user has clicked the “SAVE” button A on the editing tool setting screen (for the process), the editing unit 12 of the data management device 1 creates the new test data based on the setting contents set on the editing tool setting screen, and stores the created new test data in the storage unit 20.

Note that the editing unit 12 creates, based on the request from the computer 3, the new test data for the line on which the plurality of steps is executed by the single instrument 2 as the robot, but is not limited thereto. For example, the editing unit 12 may create, based on a request from the computer 3, new test data for a line on which different steps are executed by a plurality of instruments 2 as robots.

For example, in a case where there are steps on a line on which three instruments 2 as robots (device numbers “R001”, “R002”, and “R003”) each execute control programs “PROG_001”, “PROG_010”, and “PROG_030”, the editing unit 12 combines test data with file names “data001”, “data010”, and “data030” so that test data assuming the steps on such a line can be created.

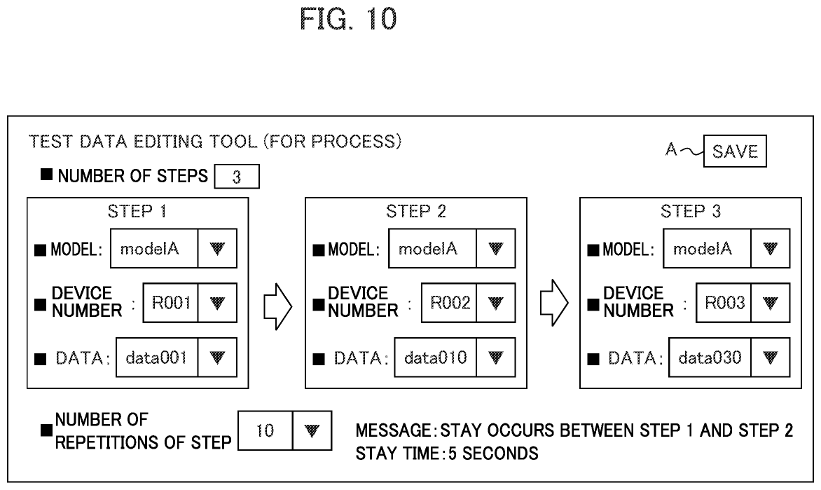

FIG. 10 is a view showing one example of the editing tool setting screen.

Note that, e.g., a setting item as the number of repetitions of the step is added to the editing tool setting screen of FIG. 10. In this case, the editing unit 12 finds a time required for each step from the combined test data with the file names “data001”, “data010”, and “data030”.

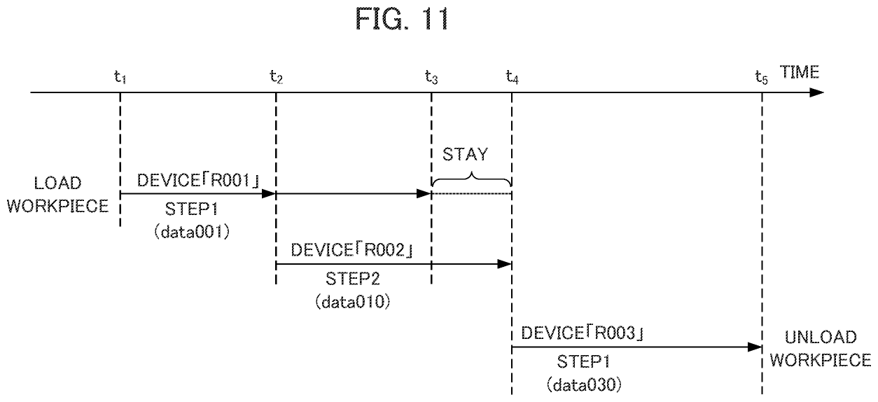

FIG. 11 is a chart showing one example of a time series of the steps in each of which a corresponding one of three instruments 2 as the robots operates.

As shown in FIG. 11, in a case where a next workpiece is loaded at a time point t₂ at which the process of Step 1 for a workpiece loaded at a time point t₁ has been completed, the editing unit 12 senses, based on the time required for each step, that there is a time during which the workpiece stays between a time point t₃ and a time point t₄ until the process of Step 2 is completed, for example. In this case, the editing unit 12 may display a message for notifying the stay and/or a stay time on the editing tool setting screen, as shown in FIG. 10.

As described above, the editing unit 12 can check, from the time required for each step in the combined test data, whether or not the stay occurs between the steps.

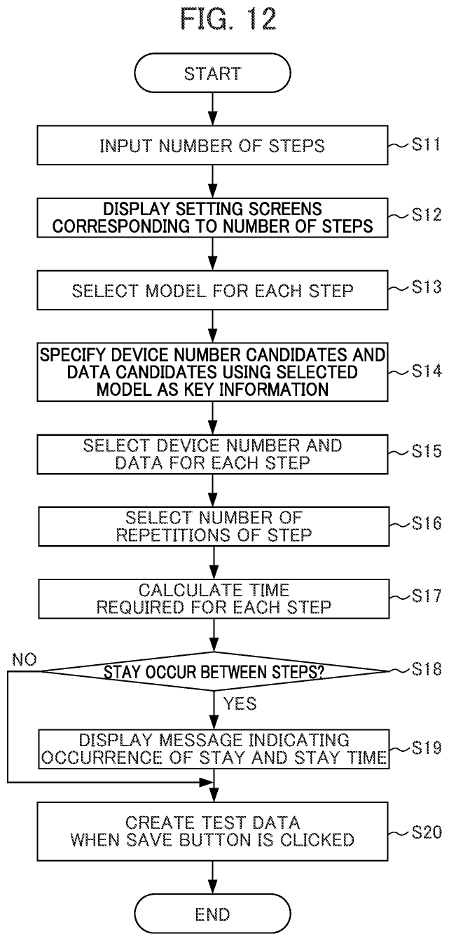

FIG. 12 is a flowchart showing, as an example, the processing of editing the test data in a case where the stay occurs.

Note that in the editing processing shown in FIG. 12, the processing in Steps 11 to S15 and Step S20 is similar to that in Steps S1 to S5 and Step S6 in FIG. 9, and therefore, description thereof will be omitted.

In Step S16, the computer 3 selects the number of repetitions of the step based on the user's input operation.

In Step S17, the editing unit 12 of the data management device 1 calculates the time required for each step from the combined test data for each step.

In Step S18, the editing unit 12 of the data management device 1 determines, based on the required time calculated for each step in Step S17, whether or not the stay occurs between the steps. In a case where the stay occurs between the steps, the processing proceeds to Step S19. On the other hand, in a case where the stay does not occur between the steps, the processing proceeds to Step S20.

In Step S19, the editing unit 12 of the data management device 1 displays the message for notifying occurrence of the stay and the stay time on the editing tool setting screen (for the process) displayed on the display device (not shown) of the computer 3.

The case where the test data is newly created using the editing tool for the process has been described above.

(2) Case where Test Data for, e.g., Load Test is Created Using Editing Tool

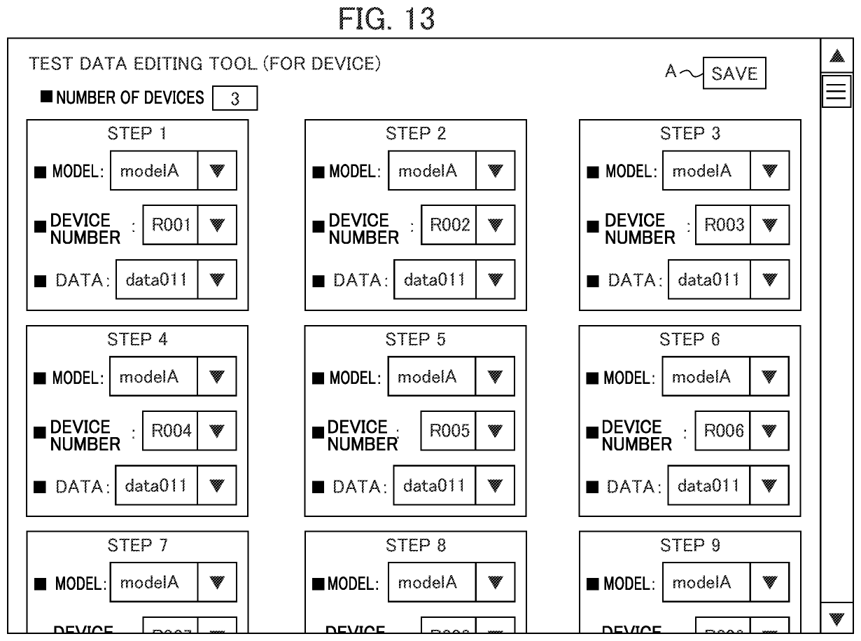

FIG. 13 is a view showing one example of an editing tool setting screen.

As shown in FIG. 13, for checking, e.g., whether or not the application 30 can normally perform the processing even when many instruments 2 as, e.g., 100 robots are simultaneously connected, the editing unit 12 displays the editing tool setting screen (for a device) on the display device (not shown) of the computer 3 in a case where the editing unit 12 has received a request for the test data for the load test for the application 30 from the computer 3.

Based on user's input operation, the computer 3 inputs, e.g., “100” as the number of devices as the instruments 2 on the editing tool setting screen (for the device). Accordingly, screens for setting each of 100 instruments 2 as the robots are shown on the editing tool setting screen (for the device) displayed on the display device (not shown) of the computer 3, as shown in FIG. 13.

For example, in a case where the computer 3 has selected a robot whose model is “modelA” based on the user's input operation, the editing unit 12 may use the selected model “modelA” as key information to conduct a search on the data stored in the storage unit 20, thereby specifying device number candidates and data candidates. On the editing tool setting screen (for the device) of FIG. 13, the computer 3 may select “R001” to “R100” as the device number of each robot based on the user's input operation. The computer 3 may select, based on the user's input operation, test data “data011” as normal system test data causing each robot to operate.

In a case where a user has clicked a “SAVE” button A on the editing tool setting screen (for the device), the computer 3 transmits, to the data management device 1, a signal including the setting contents set on the editing tool setting screen.

Based on the setting contents included in the signal received from the computer 3, the editing unit 12 reads, from the storage unit 20, test data including a model “modelA” and device numbers “R001” to “R100” as data attributes and having a file name “data011”. The editing unit 12 stores, as new test data, a combination of the read test data including the model “modelA” and the device numbers “R001” to “R100” and having the file name “data011” in the storage unit 20.

The communication control unit 13 acquires the created new test data from the storage unit 20 based on the request from the computer 3, and controls transmission of the requested new test data to the computer 3. Then, the communication unit 14 converts, based on transmission control by the communication control unit 13, the requested test data into a protocol with which the instrument 2 complies, such as OPC UA (registered trademark) or MTConnect (registered trademark), and transmits such data to the computer 3.

Accordingly, the computer 3 can test the application 30 for the load test with 100 instruments 2 as the robots operated in a connected state.

Note that the editing unit 12 creates the new test data by means of the normal system test data on 100 instruments 2 as the robots, but is not limited thereto.

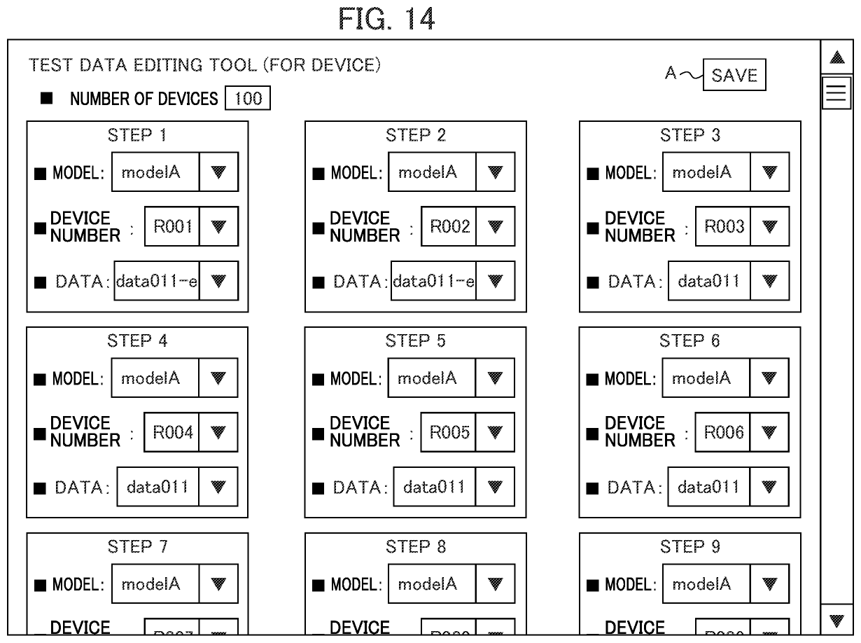

FIG. 14 is a view showing one example of the editing tool setting screen.

As shown in FIG. 14, the editing unit 12 may create new test data which is abnormal system test data as test data on part of 100 instruments 2 as the robots, for example. In FIG. 14, abnormal system test data “data011-e” may be selected as test data on instruments 2 whose model is “modelA” and whose device numbers are “R001” and “R002”.

The editing unit 12 reads, from the storage unit 20, the test data including the model “modelA” and the device numbers “R001” to “R100” and having the file name “data011”, but is not limited thereto. For example, from the storage unit 20, the editing unit 12 may read test data, which has a file name “data011”, on a single instrument 2 as a robot whose model is “modelA” and whose device number is “R001”. Then, the editing unit 12 may copy the read test data as test data on the remaining 99 instruments 2 as robots whose model is “modelA” and whose device numbers are “R002” to “R100”. Then, the editing unit 12 may create, as new test data, a combination of the test data on 100 instruments 2 as the robots, and store such data in the storage unit 20.

The editing unit 12 may create new test data causing each of 100 instruments 2 as the robots to execute a plurality of steps. Preferably, in this case, the editing unit 12 creates, for each of 100 instruments 2 as the robots, test data for executing three steps in advance by combining normal system test data with file names “data001”, “data002”, and “data003”, and stores such data with a file name “data0123” in the storage unit 20, as shown in FIG. 6.

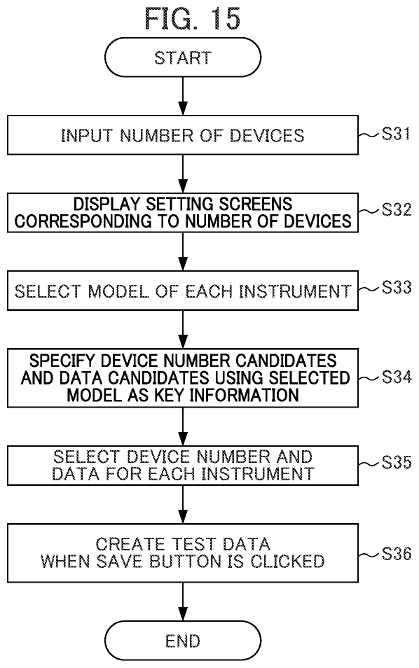

FIG. 15 is a flowchart showing, as an example, the processing of editing the test data in a case where the plurality of instruments 2 is selected.

In Step S31, the computer 3 inputs, based on the user's input operation, the number of devices as the instruments 2 on the editing tool setting screen (for the device) displayed on the display device (not shown) of the computer 3.

In Step S32, the computer 3 displays setting screens corresponding to the number of devices input in Step S31 on the editing tool setting screen (for the device) displayed on the display device (not shown) of the computer 3.

In Step S33, the computer 3 selects the model of each instrument 2 based on the user's input operation.

In Step S34, the editing unit 12 of the data management device 1 uses the model selected in Step S33 as key information to specify device number candidates and data candidates.

In Step S35, the computer 3 selects the device number of each instrument 2 and the data on each instrument 2 based on the user's input operation.

In Step S36, in a case where the user clicks the “SAVE” button A on the editing tool setting screen (for the device), the editing unit 12 of the data management device 1 creates the new test data based on the setting contents set on the editing tool setting screen, and stores the created new test data in the storage unit 20.

The case where the test data for, e.g., the load test is created using the editing tool has been described above.

(3) Case where Desired Test Data is Created Using Editing Tool

The editing unit 12 may extract part of test data stored in the storage unit 20 according to a request from the computer 3, thereby creating new test data.

Hereinafter, the case of an application 30 for performing a reducer diagnosis for diagnosing a deterioration level of a reducer for a robot shaft will be described, but the same also applies to applications other than that for the reducer diagnosis.

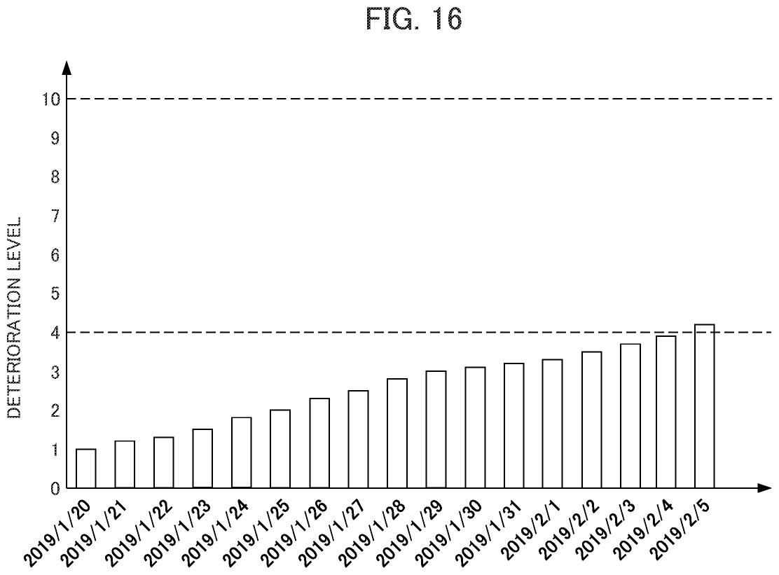

FIG. 16 is a graph showing one example of time-series data on the deterioration level of the reducer for the robot shaft. The vertical axis in FIG. 16 indicates the deterioration level, and the horizontal axis in FIG. 16 indicates a date. The deterioration level in FIG. 16 is measured in a cycle of 1 day based a well-known technique such as fluctuation in a current value supplied to a motor (not shown) that drives the reducer or fluctuation in a torque value generated by the motor, and measurement values from Jan. 20, 2019 to Feb. 5, 2019 are stored in the storage unit 20.

Note that the application 30 for the reducer diagnosis based on the deterioration level in FIG. 16 determines that the reducer has an abnormality and outputs an alert for notifying the abnormality in a case where the deterioration level is “4” or greater, and determines that the reducer is broken and outputs an alert for notifying such breakage in a case where the deterioration level is “10” or greater.

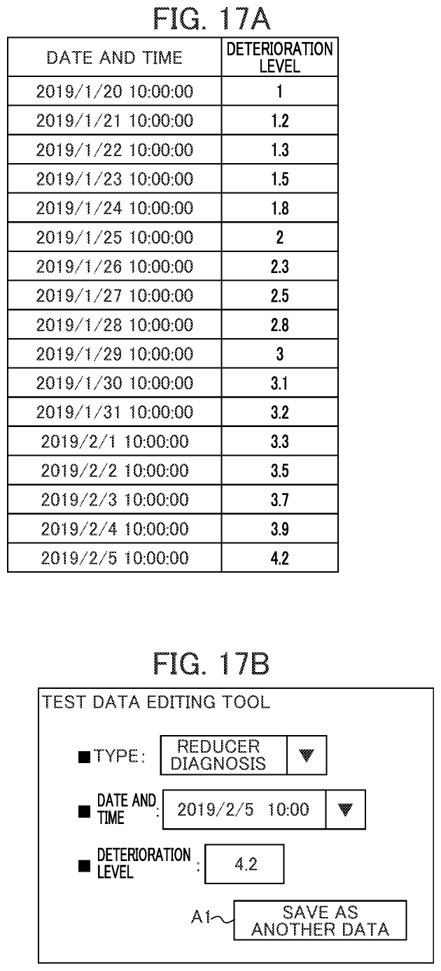

FIG. 17A is a table showing one example of time-series data for the reducer diagnosis, the time-series data having a date-and-time field and a deterioration level field. FIG. 17B is a view showing one example of an editing tool setting screen.

Specifically, in a case where the editing unit 12 has received a request for the test data for the application 30 for the reducer diagnosis from the computer 3, the editing unit 12 displays the editing tool setting screen shown in FIG. 17B together with the time-series data, which has the date-and-time field and the deterioration level field shown in FIG. 17A, on the reducer diagnosis on the display device (not shown) of the computer 3. Note that the time-series data of FIG. 17A is the same as that of FIG. 16.

For example, in a case where the computer 3 has selected “REDUCER DIAGNOSIS” as the type of diagnosis by means of the editing tool of FIG. 17B based on user's input operation, the editing unit 12 may use the selected “REDUCER DIAGNOSIS” as key information to conduct a search on the deterioration level stored in the storage unit 20, thereby specifying date-and-time candidates and deterioration level candidates. Then, the computer 3 may acquire the time-series data on the deterioration level from the data management device 1, and as shown in FIG. 17A, display the date-and-time field and the deterioration level field in the acquired time-series data. For example, for testing whether or not the application 30 for the reducer diagnosis outputs the alert indicating the abnormality in a case where the deterioration level is “4” or greater, the computer 3 may display, based on the user's input operation, “4.2” in the deterioration level field in a case where date and time “Feb. 5, 2019 10:00” has been selected by means of the editing tool of FIG. 17B.

Then, in a case where a user has clicked a “SAVE AS ANOTHER DATA” button A1 by means of the editing tool, the computer 3 transmits, to the data management device 1, a signal including the setting contents set on the editing tool setting screen.

Based on the setting contents included in the signal received from the computer 3, the editing unit 12 extracts data with date and time “Feb. 5, 2019 10:00” and a deterioration level “4.2” from the deterioration level data stored in the storage unit 20. The editing unit 12 stores the extracted data as new test data in the storage unit 20.

The communication control unit 13 acquires the created new test data from the storage unit 20 based on the request from the computer 3, and controls transmission of the requested new test data to the computer 3. Then, the communication unit 14 converts, based on transmission control by the communication control unit 13, the requested test data into a protocol with which the instrument 2 complies, such as OPC UA (registered trademark) or MTConnect (registered trademark), and transmits such data to the computer 3.

Accordingly, the computer 3 can test, in a case where the deterioration level is “4” or greater, whether or not the application 30 for the reducer diagnosis outputs the alert indicating the abnormality, i.e., whether or not the application 30 for the reducer diagnosis operates as designed.

Note that the editing unit 12 may conduct a search on the time-series data for the reducer diagnosis according to the deterioration level (e.g., “4” or greater), and display deterioration level data with date and time “Feb. 5, 2019 10:00” by means of the editing tool.

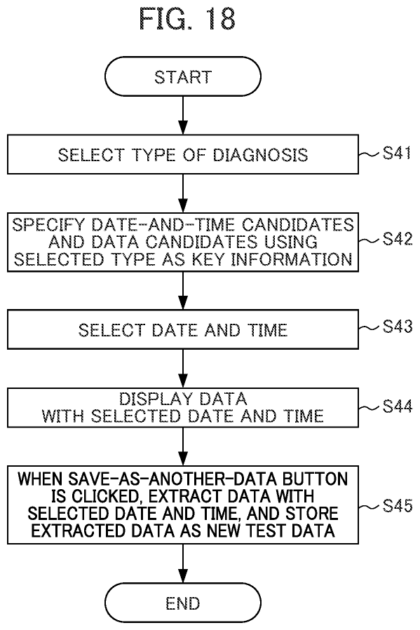

FIG. 18 is a flowchart showing, as an example, the processing of editing the test data in a case where the desired test data is extracted from the time-series data.

In Step S41, the computer 3 selects, based on the user's input operation, the type of diagnosis for, e.g., the reducer diagnosis on the editing tool setting screen displayed on the display device (not shown) of the computer 3.

In Step S42, the editing unit 12 of the data management device 1 uses the type selected in Step S41 as key information to specify date-and-time candidates and data candidates.

In Step S43, the computer 3 selects date and time based on the user's input operation.

In Step S44, the computer 3 displays data with the date and time selected in Step S43.

In Step S45, in a case where the user has clicked the “SAVE AS ANOTHER DATA” button A1 on the editing tool setting screen, the editing unit 12 of the data management device 1 extracts the data with the date and time selected in Step S43, and stores such data as new test data in the storage unit 20.

Note that the editing unit 12 extracts a single piece of date-and-time data based on a request from the computer 3 and creates new test data, but is not limited thereto. For example, the editing unit 12 may extract data corresponding to a period specified by a request from the computer 3.

For example, test data obtained by extraction of data corresponding to a period during which the deterioration level is “3” or greater is used so that the application function of transmitting a mail when the deterioration level reaches “4” or greater can be tested.

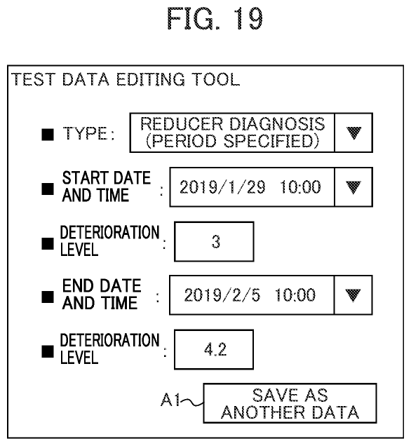

FIG. 19 is a view showing one example of the editing tool setting screen.

As shown in FIG. 19, in a case where the editing unit 12 has received the request for the test data for the application 30 for the reducer diagnosis from the computer 3, the editing unit 12 may display the editing tool setting screen together with the time-series data having the date-and-time field and the deterioration level field of FIG. 17A on the display device (not shown) of the computer 3.

For example, in a case where the computer 3 has selected, based on the user's input operation, “REDUCER DIAGNOSIS (PERIOD SPECIFIED)” as the type of diagnosis by means of the editing tool of FIG. 19, the editing unit 12 may use the selected “REDUCER DIAGNOSIS (PERIOD SPECIFIED)” as key information to conduct a search on the deterioration level stored in the storage unit 20, thereby specifying date-and-time candidates and deterioration level candidates. On the display device (not shown) of the computer 3, the computer 3 may display the date-and-time field and the deterioration level field in the time-series data as shown in FIG. 17A, and may display the editing tool including a start date-and-time field, a field of the deterioration level at start date and time, an end date-and-time field, and a field of the deterioration level at end date and time as shown in FIG. 19. Based on the user's input operation, the computer 3 selects “Jan. 29, 2019 10:00” in the start date-and-time field, and selects “Feb. 5, 2019 10:00” in the end date-and-time field. Accordingly, the field of the deterioration level at the start date and time displays “3”, and the field of the deterioration level at the end date and time displays “4.2”.

Then, in a case where the user has clicked the “SAVE AS ANOTHER DATA” button A1 by means of the editing tool, the computer 3 transmits, to the data management device 1, the signal including the setting contents set on the editing tool setting screen.

Based on the setting contents included in the signal received from the computer 3, the editing unit 12 extracts data on the deterioration level for a period from start date and time “Jan. 29, 2019 10:00” to end date and time “Feb. 5, 2019 10:00” from the deterioration level data stored in the storage unit 20. The editing unit 12 stores, in the storage unit 20, the extracted data as new test data.

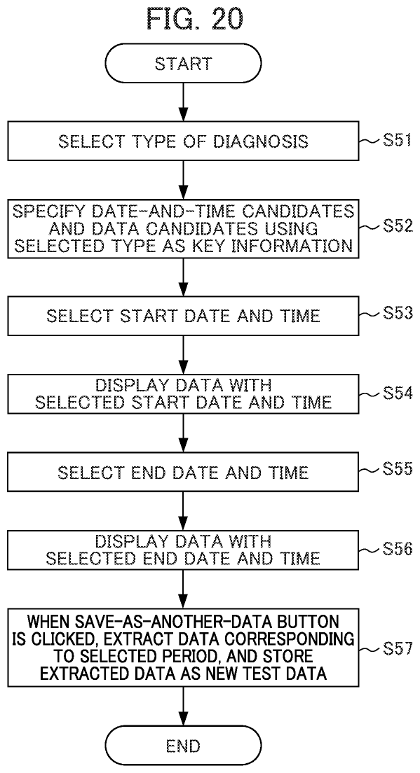

FIG. 20 is a flowchart showing, as an example, the processing of editing the test data in a case where the period to be extracted is specified.

Note that in the editing processing shown in FIG. 20, the processing in Steps S51 and S52 is similar to that in Steps S41 and S42 in FIG. 18, and therefore, description thereof will be omitted.

In Step S53, the computer 3 selects start date and time based on the user's input operation.

In Step S54, the computer 3 displays data with the start date and time selected in Step S53.

In Step S55, the computer 3 selects end date and time based on the user's input operation.

In Step S56, the computer 3 displays data with the end date and time selected in Step S55.

In Step S57, in a case where the user has clicked the “SAVE AS ANOTHER DATA” button A1 on the editing tool setting screen, the editing unit 12 of the data management device 1 extracts data corresponding to the period selected in Steps S54 and S56, and stores such data as new test data in the storage unit 20.

The case where the desired test data is created using the editing tool has been described above.

(4) Case where Test Data Parameter is Changed Using Editing Tool

For example, as shown in FIG. 16, even if the time-series data on the deterioration level shows “4” or greater that is determined as the reducer having the abnormality, the time-series data rarely shows “10” or greater that is determined as the reducer being broken. For this reason, it is difficult for the computer 3 to test whether or not the application 30 for the reducer diagnosis outputs the alert indicating breakage of the reducer in a case where the deterioration level is “10” or greater.

Thus, the editing unit 12 extracts part of the test data stored in the storage unit 20 based on a request from the computer 3, and changes a parameter, e.g., the deterioration level, of the extracted test data to “10” or greater to create new test data.

Hereinafter, the case of an application 30 for performing a reducer diagnosis for diagnosing a deterioration level of a reducer for a robot shaft will be described, but the same also applies to applications other than that for the reducer diagnosis.

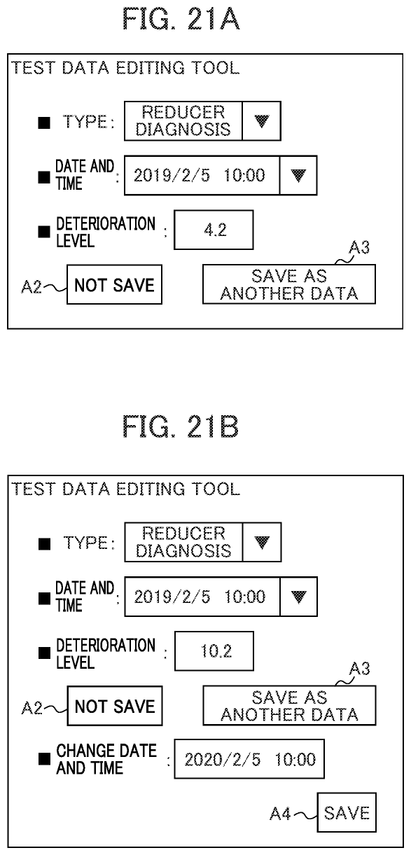

FIG. 21A is a view showing one example of an editing tool setting screen.

As shown in FIG. 21A, in a case where the editing unit 12 has received a request for test data for the application 30 for the reducer diagnosis from the computer 3, the editing unit 12 displays the date-and-time field and the deterioration level field in the time-series data of FIG. 17A and the editing tool setting screen of FIG. 21A on the display device (not shown) of the computer 3.

For example, in a case where the computer 3 has selected “REDUCER DIAGNOSIS” as the type of diagnosis by means of the editing tool of FIG. 21A based on user's input operation, the editing unit 12 may use the selected “REDUCER DIAGNOSIS” as key information to conduct a search on the deterioration level stored in the storage unit 20, thereby specifying date-and-time candidates and deterioration level candidates. Then, the computer 3 may acquire time-series data on the deterioration level from the data management device 1, and as shown in FIG. 17A, may display the date-and-time field and the deterioration level field in the acquired time-series data. For testing whether or not the application 30 for the reducer diagnosis outputs an alert indicating breakage of the reducer in a case where the deterioration level is “10” or greater, the computer 3 may display, based on the user's input operation, “4.2” in the deterioration level field in a case where date and time “Feb. 5, 2019 10:00” has been selected by means of the editing tool of FIG. 21A, for example.

FIG. 21B is a view showing one example of the editing tool setting screen after the deterioration level has been changed.

For example, in a case where a user has changed the deterioration level in the deterioration level field to “10.2” by means of the editing tool of FIG. 21A and has clicked a “SAVE AS ANOTHER DATA” button A3, the computer 3 displays, based on the user's input operation, a changed date-and-time input field and a “SAVE” button A4 by means of the editing tool as shown in FIG. 21B. For example, in a case where the user has input “2020/2/5 10:00” to the changed date-and-time input field and has clicked the “SAVE” button A4, the computer 3 transmits, based on the user's input operation, a signal including the setting contents set on the editing tool setting screen of FIG. 21B to the data management device 1.

Based on the setting contents included in the signal received from the computer 3, the editing unit 12 extracts data with date and time “Feb. 5, 2019 10:00” and a deterioration level “4.2” from the deterioration level data stored in the storage unit 20. The editing unit 12 changes the extracted data to data with date and time “2020/2/5 10:00” and a deterioration level “10.2”, and stores such data as new test data in the storage unit 20.

The communication control unit 13 acquires the created new test data from the storage unit 20 based on the request from the computer 3, and controls transmission of the requested new test data to the computer 3. Then, the communication unit 14 converts, based on transmission control by the communication control unit 13, the requested test data into a protocol that the instrument 2 complies, such as OPC UA (registered trademark) or MTConnect (registered trademark), and transmits such data to the computer 3.

Accordingly, the computer 3 can test, in a case where the deterioration level is “10” or greater, whether or not the application 30 for the reducer diagnosis outputs the alert indicating breakage of the reducer, i.e., whether or not the application 30 for the reducer diagnosis operates as designed.

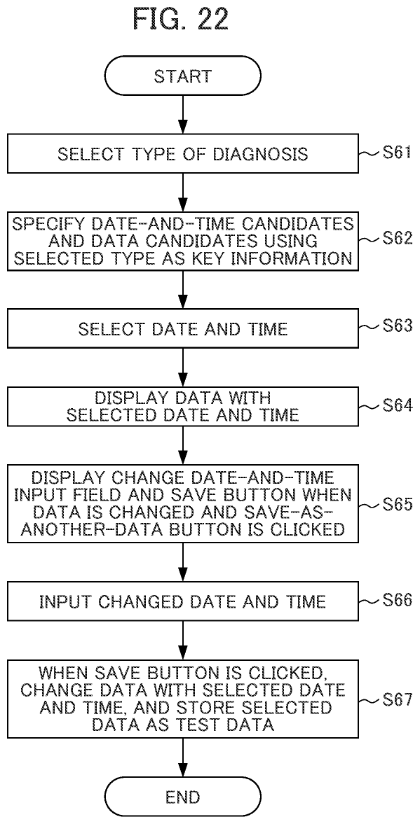

FIG. 22 is a flowchart showing, as an example, the processing of editing the test data in a case where the parameter of the time-series data is changed.

Note that in the editing processing shown in FIG. 22, the processing in Steps S61 to S64 is similar to that in Steps S41 to S44 in FIG. 18, and therefore, description thereof will be omitted.

In Step S65, in a case where the user has changed the data in the deterioration level field and has clicked the “SAVE AS ANOTHER DATA” button A3, the computer 3 displays, based on the user's input operation, the changed date-and-time input field and the “SAVE” button A4 by means of the editing tool.

In Step S66, the computer 3 inputs changed date and time to the changed date-and-time input field based on the user's input operation.

In Step S67, in a case where the user has clicked the “SAVE” button A4 on the editing tool setting screen, the editing unit 12 of the data management device 1 changes the data with the date and time selected in Step S64 to the contents input in Steps S65 and S66, and stores such data as new test data in the storage unit 20.

The case where the test data parameter is changed using the editing tool has been described above.

### <Processing of Data Management Device 1>

Operation relating to the processing of the data management device 1 according to the present embodiment will be described.

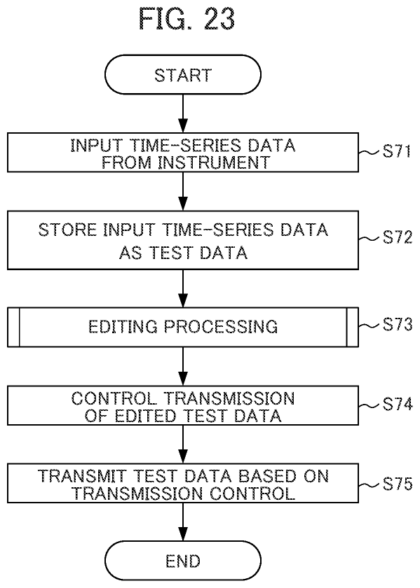

FIG. 23 is a flowchart for describing the processing of the data management device 1.

In Step S71, the input unit 11 inputs the time-series data from the instrument 2 such as the robot, the control device, or the sensor.

In Step S72, the storage unit 20 stores the time-series data input in Step S71.

In Step S73, the editing unit 12 performs any editing processing of FIGS. 9, 12, 15, 18, 20, and 22 according to the request from the computer 3, and stores the data as new test data in the storage unit 20.

In Step S74, the communication control unit 13 acquires the test data edited in Step S73 from the storage unit 20, and controls transmission of the requested new test data to the computer 3.

In Step S75, the communication unit 14 transmits, based on transmission control in Step S74, the requested new test data to the computer 3.

Note that in a case where the time-series data from the instrument 2 has been already stored in the storage unit 20, the processing in Steps S71 and S72 in the flow of FIG. 23 may be omitted.

With the above-described configuration, the data management device 1 of the first embodiment executes the normal and abnormal system programs for various instruments 2 such as the robot, the control device, and the sensor, thereby storing the normal and abnormal system time-series data output from the instruments 2 as the test data. The data management device 1 edits the test data based on the request from the computer 3, and stores the edited test data and transmits such data to the computer 3.

Accordingly, the data management device 1 can provide the test data on various instruments for testing the application 30. Moreover, the computer 3 can test the application 30.

The first embodiment has been described above.

### Second Embodiment

Next, a second embodiment will be described. In the second embodiment, a data management device 1 controls transmission of requested test data based on a transmission interval or a transmission time point requested from a computer 3 in addition to the functions of the first embodiment.

With this configuration, an application can be tested under conditions similar to the specifications of an instrument that is a target of the application.

Hereinafter, the second embodiment will be described.

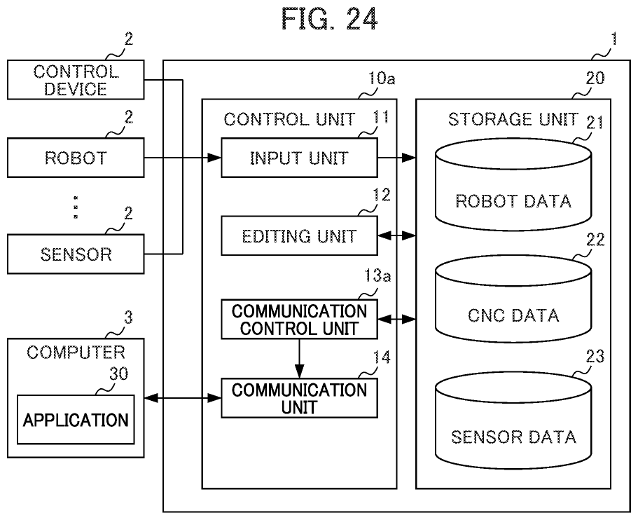

FIG. 24 is a diagram showing a functional configuration of the data management device 1 according to the second embodiment. Note that the same reference numerals are used to represent elements having functions similar to those of the elements of the data management device 1 of FIG. 1, and detailed description thereof will be omitted.

As shown in FIG. 24, the data management device 1 according to the second embodiment has a control unit 10a and a storage unit 20.

As in the storage unit 20 of the first embodiment, the storage unit 20 has robot data 21, CNC data 22, and the sensor data 23.

The control unit 10a has an input unit 11, an editing unit 12, a communication control unit 13a, and a communication unit 14. The control unit 10a executes predetermined software (a data management program) stored in the storage unit 20, thereby implementing each function of the second embodiment.

The input unit 11, the editing unit 12, and the communication unit 14 have functions similar to those of the input unit 11, the editing unit 12, and the communication unit 14 in the first embodiment.

As in the communication control unit 13 of the first embodiment, the communication control unit 13a acquires requested test data from the storage unit 20 based on a request from the computer 3, and controls transmission of the requested test data to the computer 3.

Moreover, the communication control unit 13a according to the second embodiment (1) converts a time stamp upon test data creation into a current time point and controls transmission of the requested test data, or (2) controls transmission of the requested test data in a transmission interval requested from the computer 3.

Hereinafter, operation of the communication control unit 13a in each case will be described.

(1) Case where Time Stamp Upon Test Data Creation is Converted into Current Time Point and Transmission of Requested Test Data is Controlled

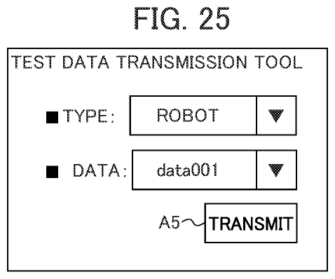

FIG. 25 is a view showing one example of a transmission tool setting screen.

As shown in FIG. 25, in a case where the communication control unit 13a has received, for example, a test data transmission instruction from the computer 3, the communication control unit 13a displays the transmission tool setting screen on a display device (not shown) of the computer 3. In a case where the computer 3 has selected “ROBOT” as the type of instrument 2 that is a target to be transmitted by means of the transmission tool of FIG. 25 based on user's input operation, the communication control unit 13a uses the selected “ROBOT” as key information to conduct a search on the test data stored in the storage unit 20, thereby specifying candidates of the test data to be transmitted. Then, based on the user's input operation, the computer 3 may select, for example, test data with a file name “data001” as shown in FIG. 2 on the transmission tool setting screen of FIG. 25.

In a case where a user has clicked a “TRANSMIT” button A5 on the transmission tool setting screen, the computer 3 transmits, to the data management device 1, a signal including the setting contents set on the transmission tool setting screen.

Based on the setting contents included in the signal received from the computer 3, the communication control unit 13a reads the test data with the file name “data001” from the storage unit 20. The communication control unit 13a converts a time stamp (e.g., Mar. 1, 2019 9:00:00:105 or Mar. 1, 2019 9:00:00:605) upon creation of the read test data with the file name “data001” into a current time point (e.g., Sep. 10, 2019 10:00:00:505 or Sep. 10, 2019 10:00:01:005), and controls transmission to the computer 3 at the interval (e.g., 500 msec) of the time stamp of the test data.

The communication unit 14 converts, based on transmission control by the communication control unit 13, the requested test data into a protocol with which the instrument 2 complies, such as OPC UA (registered trademark) or MTConnect (registered trademark), and transmits such data to the computer 3.

With this configuration, previously-created test data can be used as current data, and can be used as if the previously-created test data is data transmitted in real time from the instrument 2 connected.

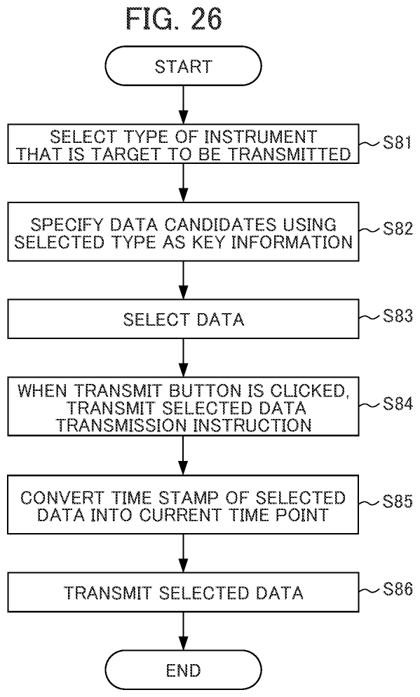

FIG. 26 is a flowchart showing, as an example, the processing of transmitting the test data according to the second embodiment.

In Step S81, based on the user's input operation, the computer 3 inputs the type of instrument 2, that is the target to be transmitted, to the transmission tool setting screen displayed on the display device (not shown) of the computer 3.

In Step S82, the communication control unit 13a of the data management device 1 uses the type selected in Step S81 as key information to specify candidates of the data to be transmitted.

In Step S83, the computer 3 selects data based on the user's input operation.

In Step S84, in a case where the user has clicked the “TRANSMIT” button A5 by means of the transmission tool, the computer 3 transmits a selected data transmission instruction to the data management device 1.

In Step S85, the communication control unit 13a converts the time stamp of the selected data into the current time point based on the transmission instruction from the computer 3, and controls transmission to the computer 3 at the interval of the time stamp of the data.

In Step S86, the communication unit 14 transmits the selected data to the computer 3 based on transmission control by the communication control unit 13a.

The case where the time stamp upon test data creation is converted into the current time point and transmission of the requested test data is controlled has been described above.

(2) Case where Transmission of Test Data is Controlled at Transmission Interval Requested from Computer 3

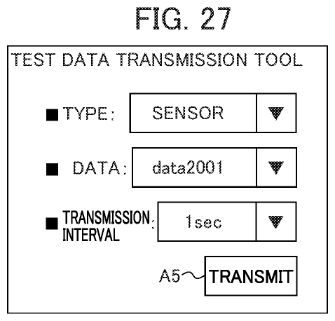

FIG. 27 is a view showing one example of a transmission tool setting screen.

As shown in FIG. 27, in a case where the communication control unit 13a has received, for example, a test data transmission interval change instruction from the computer 3, the communication control unit 13a displays the transmission tool setting screen on the display device (not shown) of the computer 3. In a case where the computer 3 has selected “SENSOR” as the type of instrument 2 that is a target to be transmitted by means of the transmission tool of FIG. 27 based on user's input operation, the communication control unit 13a uses the selected “SENSOR” as key information to conduct a search on the test data stored in the storage unit 20, thereby specifying candidates of the test data to be transmitted. Then, based on the user's input operation, the computer 3 may select, for example, the test data of FIG. 5 (e.g., a file name “data2001”) on the transmission tool setting screen of FIG. 27. Moreover, based on the user's input operation, the computer 3 selects, for example, “1 sec” as the transmission interval of the selected test data on the transmission tool setting screen of FIG. 27.

In a case where the user has clicked a “TRANSMIT” button A5 on the transmission tool setting screen, the computer 3 transmits, to the data management device 1, a signal including the setting contents set on the transmission tool setting screen.

Based on the setting contents included in the signal received from the computer 3, the communication control unit 13a reads the test data with the file name “data2001” from the storage unit 20. The communication control unit 13a controls transmission of the read test data with the file name “data2001” to the computer 3 at an interval of 1 second indicated by the setting contents instead of an interval of 1 minute indicated by the time stamp of such test data.

The communication unit 14 converts, based on transmission control by the communication control unit 13a, the requested test data into a protocol with which the instrument 2 complies, such as OPC UA (registered trademark) or MTConnect (registered trademark), and transmits such data to the computer 3.

With this configuration, previously-created test data can be used as current data, and can be used as if the previously-created test data is data transmitted in real time from the instrument 2 connected. Further, the function of the application can be tested within a shorter time.

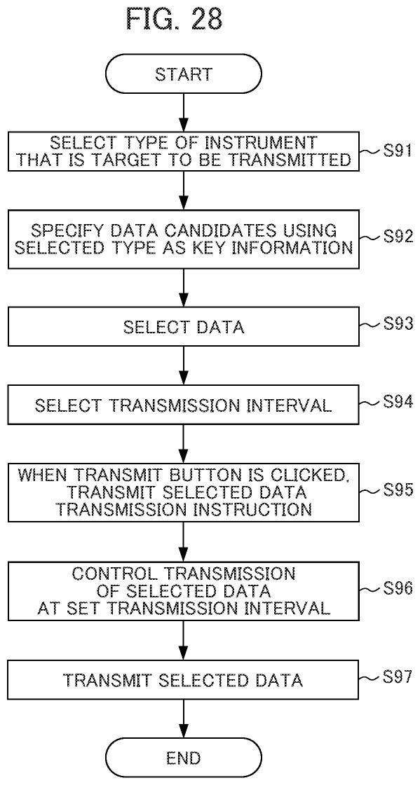

FIG. 28 is a flowchart showing, as an example, the processing of transmitting the test data in a case where the transmission interval is changed.

Note that in the transmission processing shown in FIG. 28, the processing in Steps S91 to S93, Step S95, and Step S97 is similar to that in Steps S81 to S83, Step S84, and Step S86 in FIG. 26, and therefore, description thereof will be omitted.

In Step S94, the computer 3 selects the transmission interval of the data selected in Step S93.

In Step S96, the communication control unit 13a controls, based on the transmission instruction from the computer 3, transmission of the data selected in Step S93 to the computer 3 at the transmission interval selected in Step S94.

The case where transmission of the test data is controlled at the transmission interval requested from the computer 3 has been described above.

With the above-described configuration, the data management device 1 of the second embodiment executes the normal and abnormal system programs for various instruments 2 such as a robot, a control device, and a sensor, thereby storing the normal and abnormal system time-series data output from the instruments 2 as the test data. The data management device 1 converts the time stamp of the test data into the current time point based on the request from the computer 3, thereby transmitting the test data to the computer 3 or transmitting the test data to the computer 3 at the instructed transmission interval.

With this configuration, the data management device 1 can provide the test data on various instruments for testing the application 30. Moreover, the data management device 1 allows the user of the computer 3 to use the previously-created test data as the current data and use the previously-created test data as if such data is the data transmitted in real time from the instrument 2 connected.

The second embodiment has been described above.

### Variation of Second Embodiment

In the second embodiment, the communication control unit 13a of the data management device 1 converts the time stamp of the test data into the current time point according to the request from the computer 3, thereby controlling transmission of the test data to the computer 3 or controlling transmission of the test data to the computer 3 at the requested transmission interval, but is not limited thereto. For example, in a case where the editing unit 12 of the data management device 1 has received the test data time stamp change instruction from the computer 3, the editing unit 12 may edit the time stamp of the test data to set the transmission time point, and the communication control unit 13a may transmit the test data to the computer 3 at the set transmission time point.

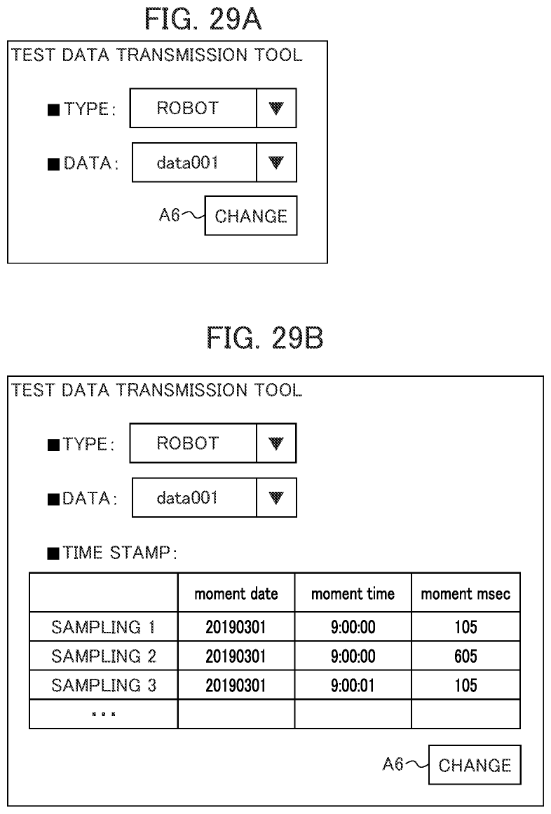

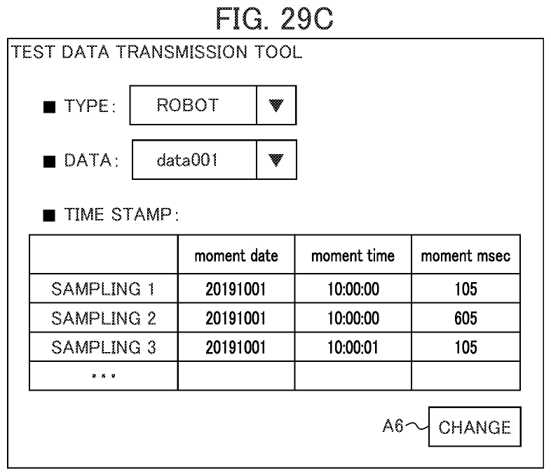

FIG. 29A is a view showing one example of an editing tool setting screen. FIG. 29B is a view showing one example of the editing tool setting screen including the list of time stamps of selected test data. FIG. 29C is a view showing one example of the editing tool setting screen after editing of the time stamps of the selected test data.

As shown in FIG. 29A, in a case where the editing unit 12 has received the test data time stamp change instruction from the computer 3, the editing unit 12 displays the editing tool setting screen on the display device (not shown) of the computer 3. In a case where the computer 3 has selected, based on the user's input operation, “ROBOT” as the type of instrument 2 that is a target to be edited by means of the editing tool of FIG. 29A, the editing unit 12 uses the selected “ROBOT” as key information to conduct a search on the test data stored in the storage unit 20, thereby specifying candidates of the test data to be edited. Then, based on the user's input operation, the computer 3 may select, for example, the test data of FIG. 2 with the file name “data001” on the editing tool setting screen of FIG. 29A. Then, the computer 3 displays the list of the time stamps of the selected test data on the screen of the editing tool as shown in FIG. 29B.

For example, the computer 3 edits the time stamps of the selected test data based on the user's input operation as shown in FIG. 29C. Then, in a case where the user has clicked a “CHANGE” button A6 on the editing tool setting screen, the computer 3 transmits, to the data management device 1, a signal including the setting contents set on the editing tool setting screen.

Based on the setting contents included in the signal received from the computer 3, the editing unit 12 reads the test data with the file name “data001” from the storage unit 20. The editing unit 12 changes each time stamp of the read test data with the file name “data001” to the time stamp included in the setting contents, and stores such data as new test data in the storage unit 20.

For example, the time point can be set according to a shift at a factory, or can be set to date and time under special conditions such as the leap year. According to work environment at an actual site such as a factory, the function of the application 30 can be tested.

The communication control unit 13a controls transmission of the test data to the computer 3 based on the time point indicated by each changed time stamp of the new test data.

The communication unit 14 converts, based on transmission control by the communication control unit 13a, the requested test data into a protocol with which the instrument 2 complies, such as OPC UA (registered trademark) or MTConnect (registered trademark), and transmits such data to the computer 3.

With this configuration, the previously-created test data can be used as data with a time point that is, including a future time point, freely set by the user, and can be used as if the previously-created test data is data transmitted from the instrument 2 connected.

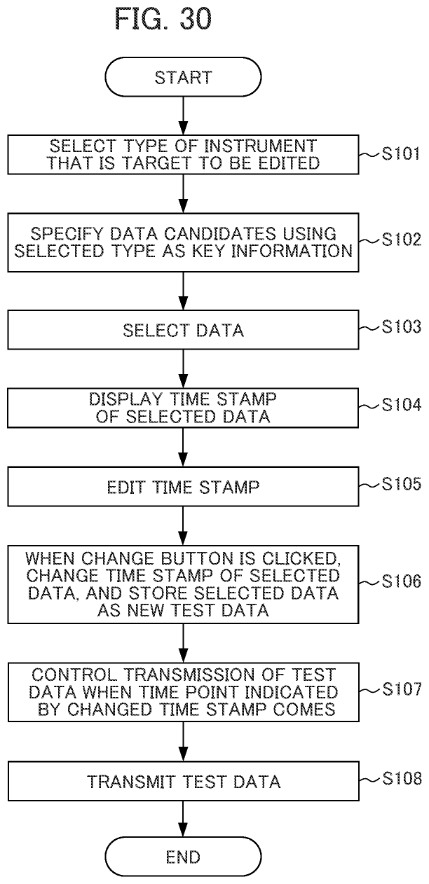

FIG. 30 is a flowchart showing, as an example, the processing of editing the test data in a case where the time stamp is changed.

In Step S101, the computer 3 selects, based on the user's input operation, the type of instrument 2 that is the target to be edited on the editing tool setting screen displayed on the display device (not shown) of the computer 3.

In Step S102, the editing unit 12 of the data management device 1 uses the type selected in Step S101 as key information to specify data candidates.

In Step S103, the computer 3 selects data based on the user's input operation.

In Step S104, the computer 3 displays the time stamp of the data selected in Step S103.

In Step S105, the computer 3 edits the time stamp displayed in Step S104 based on the user's input operation.

In Step S106, in a case where the user has clicked the “CHANGE” button A6 on the editing tool setting screen, the editing unit 12 of the data management device 1 changes the time stamp of the data selected in Step S103 to the time stamp edited in Step S105 to create new test data, and stores such data in the storage unit 20.

In Step S107, the communication control unit 13a of the data management device 1 controls transmission of the new test data created in Step S106 to the computer 3 when the time point indicated by the time stamp changed in Step S106 comes.

In Step S108, the communication unit 14 transmits the test data to the computer 3 based on transmission control by the communication control unit 13a.

The first embodiment, the second embodiment, and the variation of the second embodiment have been described above, but the data management device 1 is not limited to those described above in the embodiments and variations, modifications, etc. are included within a scope in which the object can be achieved.

### <Variations>

In the first embodiment, the second embodiment, and the variation of the second embodiment, the data management device 1 has been described as a device different from the computer 3 by way of example, but some or all of the functions of the data management device 1 may be included in the computer 3.

Alternatively, part or the entirety of the control unit 10 and the storage unit 20 of the data management device 1 may be included in the server, for example. Utilizing, e.g., a virtual server function on the cloud, each function of the data management device 1 may be implemented.

The data management device 1 may be a distributed processing system that distributes the functions of the data management device 1 to a plurality of servers as necessary.

Note that each function of the data management device 1 in the first embodiment, the second embodiment, and the variation of the second embodiment can be implemented by hardware, software, or a combination thereof. Implementation by the software as described herein means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PRPM), an erasable PROM (EPROM), a flash ROM, and a RAM). The program may be supplied to the computer by various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

Note that the step of describing the program recorded in the recording medium includes, needless to say, not only processing performed in chronological order but also processing not necessarily performed in chronological order but executed in parallel or individually.

In other words, the data management device and the data management method of the present disclosure can be implemented as various embodiments having the following configurations.

(1) The data management device 1 of the present disclosure includes the input unit 11 configured to input data from at least one instrument 2, the storage unit 20 configured to store, as test data, the data input from the input unit 11, the communication control unit 13 configured to acquire, from the storage unit 20, requested test data based on a request from the computer 3 and control transmission of the requested test data to the computer 3, and the communication unit 14 configured to transmit the requested test data to the computer 3 based on transmission control by the communication control unit 13.

According to the data management device 1, the test data for various instruments for testing the application 30 can be provided.

(2) The data management device 1 according to (1) may further include the editing unit 12 configured to edit the test data stored in the storage unit 20 according to the request from the computer 3.

With this configuration, the data management device 1 can combine the test data for a plurality of steps, thereby creating new test data. Moreover, the data management device 1 edits the time stamp of the test data so that previously-created test data can be used as data with a time point that is, including a future time point, freely set by the user, and can be used as if the previously-created test data is data transmitted from the instrument 2 connected.

(3) In the data management device 1 according to (1) or (2), the communication control unit 13a may control transmission of the requested test data based on a transmission interval or a transmission time point requested from the computer 3.

With this configuration, the data management device 1 can use the previously-created test data as current data, and can use such data as if the previously-created test data is data transmitted in real time from the instrument 2 connected.

(4) The data management method of the present disclosure includes inputting data from at least one instrument 2, storing, as test data, the input data in the storage unit 20, acquiring, from the storage unit 20, requested test data based on a request from the computer 3 and controlling transmission of the requested test data to the computer 3, and transmitting the requested test data to the computer 3 based on transmission control.

According to this data management method, advantageous effects similar to those of (1) can be produced.

(5) In the data management method according to (4), the test data stored in the storage unit 20 may be edited according to the request from the computer 3.

With this configuration, advantageous effects similar to those of (2) can be produced.

(6) In the data management method according to (4) or (5), transmission of the requested test data may be controlled based on a transmission interval or a transmission time point requested from the computer 3.

With this configuration, advantageous effects similar to those of (3) can be produced.

### EXPLANATION OF REFERENCE NUMERALS

1 Data Management Device
10, 10a Control Unit
11 Input Unit
12 Editing Unit
13, 13a Communication Control Unit
14 Communication Unit
20 Storage Unit
21 Robot Data
22 CNC Data
23 Sensor Data
2 Instrument
3 Computer

1. A data management device comprising:
an input unit configured to input data from at least one instrument;
a storage unit configured to store, as test data, the data input from the input unit;
a communication control unit configured to acquire, from the storage unit, requested test data based on a request from an external device and control transmission of the requested test data to the external device; and
a communication unit configured to transmit the requested test data to the external device based on the transmission control by the communication control unit.

2. The data management device according to claim 1, further comprising: an editing unit configured to edit the test data stored in the storage unit according to the request from the external device.

3. The data management device according to claim 1, wherein the communication control unit controls the transmission of the requested test data based on a transmission interval or a transmission time point requested from the external device.

4. A data management method comprising:
inputting data from at least one instrument;
storing, as test data, the input data in a storage unit;
acquiring, from the storage unit, requested test data based on a request from an external device and controlling transmission of the requested test data to the external device; and
transmitting the requested test data to the external device based on the transmission control.

5. The data management method according to claim 4, wherein the test data stored in the storage unit is edited according to the request from the external device.

6. The data management method according to claim 4, wherein the transmission of the requested test data is controlled based on a transmission interval or a transmission time point requested from the external device.
